(19) United States
(12) Patent Application Publication
(10) Pub. No.: US 2010/0040416 A1
(43) Pub. Date: Feb. 18, 2010

(54) METHOD FOR CONSTRUCTION OF WASTE LANDFILLS

(76) Inventor: Young Kwon Kang, Seoul (KR)

Correspondence Address: CHRISTOPHER PAUL MITCHELL, 888 16TH ST., NW, SUITE 800, WASHINGTON, DC, 20006, US

(21) Appl. No.: 12/442,707

(22) PCT Filed: Jun. 27, 2007
(86) PCT No.: PCT/KR07/03115

§ 371 Date: Mar. 24, 2009

(30) Foreign Application Priority Data
Sep. 25, 2006 (KR) 10-2006-0093146

(51) Int. Cl. B09B 1/00

(52) U.S. Cl. 405/129.6

(57) ABSTRACT

A method of constructing a waste landfill includes a waste reclamation site construction step, an air dome installation step of covering the top of the waste reclamation site with an air dome, a partial waste stacking step of partially stacking waste in the waste reclamation site, an air dome supporting structure installation step, a reclamation step of fully filling waste into the waste reclamation site and covering the waste reclamation site with earth, a new waste reclamation site construction step of constructing a new waste reclamation site, and an air dome transfer step of transferring the air dome. The new waste reclamation site construction step and the air dome transfer step are repeatedly carried out to continuously fill waste into the waste reclamation sites and to maximize the waste reclamation sites, thereby improving the utilizeability of the waste landfill.

### TECHNICAL FIELD

The present invention relates to a method of constructing a waste landfill, and, more particularly, to a method of constructing a waste landfill that is capable of forming a waste reclamation site, filling waste into the waste reclamation site, and forming a new waste reclamation site adjacent a small bank directly connected to the waste reclamation site, thereby maximizing the area of the waste reclamation sites, and therefore, increasing the reclamation amount of the waste landfill.

### BACKGROUND ART

At the present time, the amount of waste discharged is being abruptly increased with an increase in population and a rise in the standard of living. Accordingly, much research is being carried out on the disposal of waste. A method of incinerating waste and a method of reclaiming waste are being widely used now. However, the waste incinerating method discharges materials causing environmental pollution. Furthermore, most communities are strongly opposed to the installation of an incinerating site. For this reason, the waste reclaiming method is preferred.

Generally, a waste disposal method using reclamation includes stacking waste to a predetermined height and covering the stacked waste with earth or a similar shielding material (normally referred to as a “barrier layer”). These steps are repeatedly carried out. That is, the waste reclamation method is a waste disposal method to naturally decompose the waste for several years or for dozens of years.

FIGS. 1 and 2 are views illustrating a general method of constructing a waste landfill.

As shown in FIGS. 1 and 2, two waste reclamation sites 10 having a size of approximately 5000 pyeong are formed, such that the upper part of each waste reclamation site is wide and the lower part of each waste reclamation site is narrow, first to construct a waste landfill 1.

Each waste reclamation site 10 includes a bottom 12 and an incline 14. The incline is formed in the shape of multi steps. At the bottom and the incline is formed a water barrier layer 25 for preventing water contained in each waste reclamation site from flowing into the ground.

Between the waste reclamation sites 10 is formed a bank 20 having a predetermined width. On each waste reclamation site 10 is mounted an air dome 30 for preventing rainwater from being introduced into each waste reclamation site.

One air dome 30 is mounted on each waste reclamation site 10. The bank 20 serves to support the air domes 30 when the air domes 30 are mounted on the respective waste reclamation sites 10.

To each air dome 30 is mounted a large-sized external air suction fan 32, which is disposed at the front of each air dome in the longitudinal direction of each air dome, for transmitting bad smells and dust generated during the reclamation to the rear of each air dome 30 such that the bad smells and dust are discharged out of each air dome by an air discharge fan 34.

In the conventional method of constructing the waste landfill, however, the bank is formed between the waste reclamation sites to support the waste reclamation sites, with the result that the reclamation amount of the waste landfill is reduced by the bank. Furthermore, two air domes are required, with the result that the air dome installation costs and the air dome transfer costs are increased.

### DISCLOSURE

### Technical Problem

Therefore, the present invention has been made in view of the above problems, and it is an object of the present invention to provide a method of constructing a waste landfill that is capable of forming a waste reclamation site, filling waste into the waste reclamation site, forming a new waste reclamation site adjacent a small bank directly connected to the waste reclamation site, and installing an air dome necessary to cover the new waste reclamation site using an air dome supporting structure mounted in the waste reclamation site, thereby maximizing the area of the waste reclamation sites, and therefore, increasing the reclamation amount of the waste landfill.

### Technical Solution

In accordance with the present invention, the above and other objects can be accomplished by the provision of a method of constructing a waste landfill, including a waste reclamation site construction step of constructing a waste reclamation site such that the upper part of the waste reclamation site is wide and the lower part of the waste reclamation site is narrow, an air dome installation step of covering the top of the waste reclamation site with an air dome after the construction of the waste reclamation site, a partial waste stacking step of partially stacking waste in the waste reclamation site after the installation of the air dome, an air dome supporting structure installation step of mounting an air dome supporting structure for supporting the air dome to the top of the partially stacked waste in the waste reclamation site, a reclamation step of fully filling waste into the waste reclamation site and covering the waste reclamation site with earth after the installation of the air dome supporting structure, a new waste reclamation site construction step of constructing a new waste reclamation site adjacent to the waste reclamation site in succession such that a small bank is formed in the waste reclamation site after the covering of the waste reclamation site with earth, and an air dome transfer step of transferring the air dome, such that one side of the air dome is supported at the air dome supporting structure and the other side of the air dome is supported at a position located in the advance direction of the new waste reclamation site, to cover the top of the new waste reclamation site with the air dome, wherein the partial waste stacking step, the air dome supporting structure installation step, the reclamation step, the new waste reclamation site construction step, and the air dome transfer step are repeatedly carried out to continuously fill waste into the waste reclamation sites and to maximize the waste reclamation sites, thereby improving the utilizeability of the waste landfill.

Preferably, the air dome supporting structure includes a supporting body, made of cement and iron rods, and a rope. The supporting body is fixed due to load of the stacked waste, the rope is connected to the supporting body by means of an anchor bolt, and the end of the rope is coupled to one side of the air dome, thereby supporting the air dome.

At the reclamation step, the waste is stacked in the shape of steps in an inclined fashion from the small bank to the air dome supporting structure, whereby the waste is prevented from falling.

The method according to the present invention has an advantage of maximizing the area of the waste reclamation sites, and therefore, increasing the reclamation amount of a waste landfill.

### ADVANTAGEOUS EFFECTS

A method of constructing a waste landfill according to the present invention includes forming a waste reclamation site, filling waste into the waste reclamation site, and forming a new waste reclamation site adjacent to a small bank directly connected to the waste reclamation site. Consequently, the present invention has the effect of maximizing the area of the waste reclamation sites, and therefore, increasing the reclamation amount of a waste landfill.

In addition, an air dome supporting structure, which is necessary for installation of an air dome to cover the top of the new waste reclamation site, is previously installed, after the waste is partially stacked in the waste reclamation site, according to the present invention. Consequently, the present invention has the effect of transferring and installing the air dome without restrictions of the air dome installation space.

Furthermore, it is possible to increase the size of the waste reclamation site and preventing rainwater from being introduced into the waste reclamation site using only one air dome according to the present invention, unlike the conventional art in which two waste reclamation sites are constructed and two air domes are installed to cover the two waste reclamation sites. Consequently, the present invention has the effect of lowering the installation costs and the transfer costs of the air dome. Moreover, the waste reclamation site construction method according to the present invention does not need a bank formed between the waste reclamation sites. Consequently, the present invention has the effect of maximizing the utilizeability of the waste landfill.

### DESCRIPTION OF DRAWINGS

The above and other objects, features and other advantages of the present invention will be more clearly understood from the following detailed description taken in conjunction with the accompanying drawings, in which:

FIGS. 1 and 2 are views illustrating a conventional method of constructing a waste landfill;

FIG. 3 is a view illustrating a method of constructing a waste landfill according to the present invention;

FIG. 4 is a sectional view illustrating the method of constructing the waste landfill according to the present invention; and

FIG. 5 is a flow chart illustrating the method of constructing the waste landfill according to the present invention.

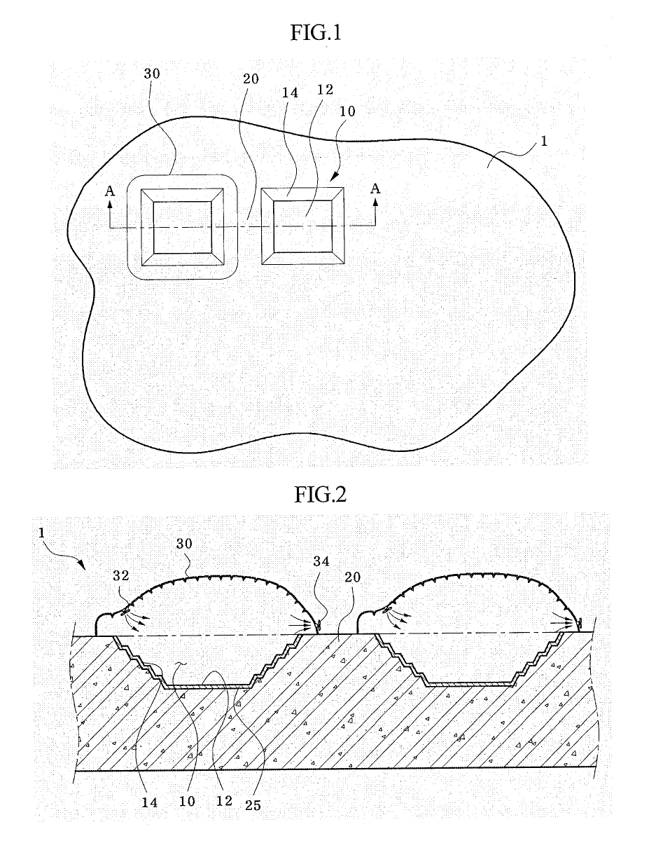

*Description of reference numerals*

100: waste landfill
110: waste reclamation site
112: bottom
114: incline
120: water barrier layer
130: small bank
140: air dome
142: external air suction fan
144: air discharge fan

### MODE FOR INVENTION

Now, a preferred embodiment of the present invention will be described in detail with reference to the accompanying drawings.

It should be noted, however, that the embodiment of the present invention does not limit the scope of right of the present invention but is provided only for illustrative purpose, and components of the present invention, which are identical in structure and operation to those of the conventional art, are denoted by the same reference numerals or titles.

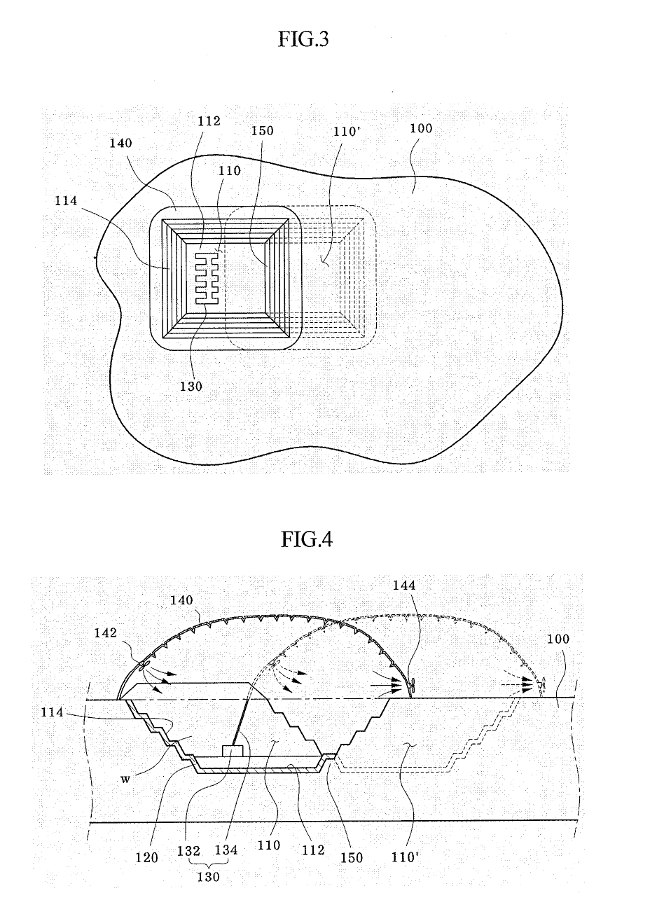

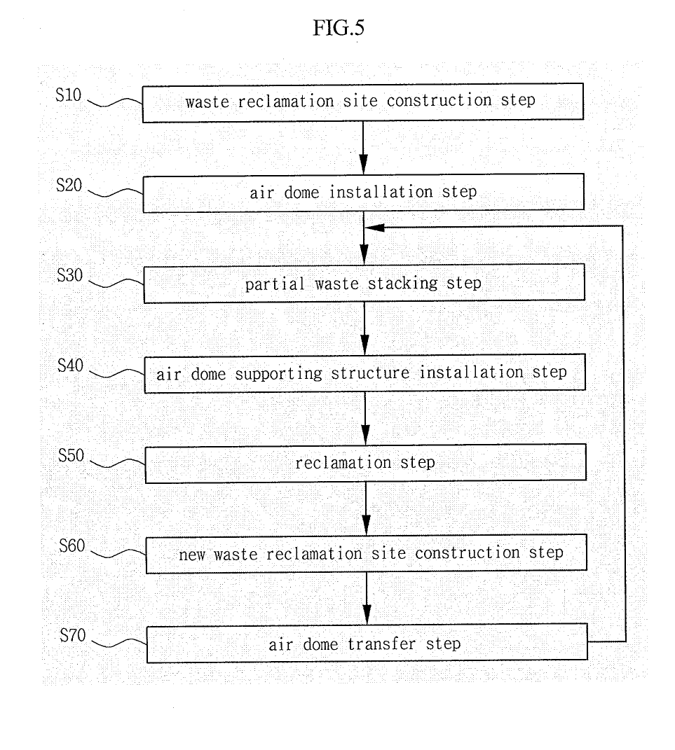

FIG. 3 is a view illustrating a method of constructing a waste landfill according to the present invention, FIG. 4 is a sectional view illustrating the method of constructing the waste landfill according to the present invention, and FIG. 5 is a flow chart illustrating the method of constructing the waste landfill according to the present invention.

As shown in these drawings, a method of constructing a waste landfill 100 according to the present invention includes a waste reclamation site construction step S10 of constructing a waste reclamation site 110 such that the upper part of the waste reclamation site is wide and the lower part of the waste reclamation site is narrow, an air dome installation step S20 of covering the top of the waste reclamation site 110 with an air dome 140 after the construction of the waste reclamation site 110, a partial waste stacking step S30 of partially stacking waste W in the waste reclamation site 110 after the installation of the air dome 140, an air dome supporting structure installation step S40 of mounting an air dome supporting structure 130 for supporting the air dome 140 to the top of the partially stacked waste W in the waste reclamation site 110, a reclamation step S50 of fully filling waste W into the waste reclamation site 110 and covering the waste reclamation site 110 with earth after the installation of the air dome supporting structure 130, a new waste reclamation site construction step S60 of constructing a new waste reclamation site 110′ adjacent to the waste reclamation site 110 in succession such that a small bank is formed in the waste reclamation site 110 after the covering of the waste reclamation site 110 with earth, and an air dome transfer step S70 of transferring the air dome 140, such that one side of the air dome 140 is supported at the air dome supporting structure 130 and the other side of the air dome 140 is supported at a position located in the advance direction of the new waste reclamation site 110′, to cover the top of the new waste reclamation site 110′ with the air dome 140. The partial waste stacking step, the air dome supporting structure installation step, the reclamation step, the new waste reclamation site construction step, and the air dome transfer step are repeatedly carried out to continuously fill waste into the waste reclamation sites and to maximize the waste reclamation sites, thereby improving the utilizeability of the waste landfill.

Specifically, the waste reclamation site 110 is formed into the shape of a hexahedron, the upper part of which is wide and the lower part of which is narrow, in the assigned waste landfill 100 at the waste reclamation site construction step S10.

A bottom 112 and an incline 114 are formed in the waste reclamation site 110. Subsequently, a water barrier layer 120 is formed by placing high density polyethylene (HDPE) water barrier film, i.e., polyethylene sheet lining, above the bottom and the incline, and filling soil mortar or soil cement, including clay having an appropriate thickness or other additives, such as bentonite, and the solidifying the soil mortar or the soil cement.

The water barrier layer 120 is applied to the bottom 112 and the incline 114 in the waste reclamation site 110 for preventing water contained in the waste W from flowing into the ground.

The incline 114 is formed in the shape of multi steps. The water barrier layer 120 is applied to the entire part at one side of the incline 114, whereas the water barrier layer 120 is applied to only the lowermost end at the other side of the incline 114.

After the construction of the waste reclamation site 110 as described above, the air dome installation step S20 of installing the air dome 140 such that the top of the waste reclamation site 110 is covered by the air dome 140 is carried out to rapidly and safely preventing the introduction of rainwater into the waste reclamation site 110.

The air dome 140 may be a dome having a frame formed therein or a floating type air dome which floats by the injection of air.

The air dome 140 is provided at the front thereof in the longitudinal direction thereof with a large-sized external air suction fan 142. At the rear of the air dome is mounted an air discharge fan 144.

Consequently, bad smells and dust, generated during the reclamation, are transmitted to the rear of the air dome 140 by the operation of the external air suction fan 142 and are then discharged out of the air dome 140 by the operation of the air discharge fan 144.

After the completion of the air dome installation step S20, the partial waste stacking step S30 is carried out to partially stack the waste W in the waste reclamation site 110.

At this time, the waste W is stacked such that the waste W does not reach the lowermost end of the incline 114.

After the waste W is partially stacked in the waste reclamation site 110, the dome supporting structure installation step S40 is carried out to mount the air dome supporting structure 130 to the top of the partially stacked waste W in the waste reclamation site 110 such that the air dome 140 is supported on the top of the partially stacked waste W.

The air dome supporting structure 130 includes a supporting body 132, made of cement and iron rods, and a rope 134. One end of the rope 134 is fixed to the supporting body 132 by means of an anchor bolt, and the other end of the rope 134 extends to the outside.

After the installation of the air dome supporting structure 130, the reclamation step S50 is carried out to fully fill the waste W into the waste reclamation site 110 and cover the waste reclamation site 110 with earth.

During the stacking of the waste W, the waste W is stacked in the shape of steps in an inclined fashion from the lowermost end at one side of the waste reclamation site 110, i.e., the region where the water barrier layer 120 is formed, to the other side of the waste reclamation site 110 such that the waste W is prevented from falling. With the stacking of the waste W, the supporting body 132 is more rigidly fixed due to the load of the waste W. At this time, the rope 134, which is connected to the supporting body 132, is still placed outside the waste W such that the rope 134 is not covered with the waste W.

After the reclamation step S50, the new waste reclamation site construction step S60 is carried out to construct the new waste reclamation site 110′ adjacent to the incline at the lowermost end of the waste reclamation site 110 in succession such that the stacked waste W is prevented from falling.

With the construction of the new waste reclamation site 110′, a small bank 150 is formed between the waste reclamation site 110 and the new waste reclamation site 110′.

After the construction of the new waste reclamation site 110′, the air dome transfer step S70 is carried out to transfer the air dome 140, located at the top of the waste reclamation site 110, to the top of the new waste reclamation site 110′ such that the top of the new waste reclamation site 110′ is covered with the air dome 140.

After the air dome 140 is transferred from the waste reclamation site 110, one side of the air dome 140 is connected to one end of the rope 134, which is connected to the supporting body 132 at the other end, and the other side of the air dome 140 is fixed to the ground outside the new waste reclamation site 110′.

The air dome supporting structure 130 is previously mounted in the waste reclamation site 110 to cover the top of the new waste reclamation site 110′. Consequently, it is possible to easily and conveniently transfer the air dome 140.

Subsequently, the partial waste stacking step S30, the air dome supporting structure installation step S40, the reclamation step S50, the new waste reclamation site construction step S60, and the air dome transfer step S70 are repeatedly carried out to continuously fill waste W into the waste reclamation sites.

### INDUSTRIAL APPLICABILITY

As apparent from the above description, a method of constructing a waste landfill according to the present invention includes forming a waste reclamation site, filling waste into the waste reclamation site, and forming a new waste reclamation site adjacent to a small bank directly connected to the waste reclamation site. Consequently, the present invention has the effect of maximizing the area of the waste reclamation sites, and therefore, increasing the reclamation amount of the waste landfill.

In addition, an air dome supporting structure, which is necessary for installation of an air dome to cover the top of the new waste reclamation site, is previously installed, after the waste is partially stacked in the waste reclamation site, according to the present invention. Consequently, the present invention has the effect of transferring and installing the air dome without restrictions of the air dome installation space.

Furthermore, it is possible to increase the size of the waste reclamation site and preventing rainwater from being introduced into the waste reclamation site using only one air dome according to the present invention, unlike the conventional art in which two waste reclamation sites are constructed and two air domes are installed to cover the two waste reclamation sites. Consequently, the present invention has the effect of lowering the installation costs and the transfer costs of the air dome. Moreover, the waste reclamation site construction method according to the present invention does not need a bank formed between the waste reclamation sites. Consequently, the present invention has the effect of maximizing the utilizeability of the waste landfill.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A method of constructing a waste landfill, comprising:
a waste reclamation site construction step of constructing a waste reclamation site such that the upper part of the waste reclamation site is wide and the lower part of the waste reclamation site is narrow;
an air dome installation step of covering the top of the waste reclamation site with an air dome after the construction of the waste reclamation site;
a partial waste stacking step of partially stacking waste in the waste reclamation site after the installation of the air dome;
an air dome supporting structure installation step of mounting an air dome supporting structure for supporting the air dome to the top of the partially stacked waste in the waste reclamation site;
a reclamation step of fully filling waste into the waste reclamation site and covering the waste reclamation site with earth after the installation of the air dome supporting structure;
a new waste reclamation site construction step of constructing a new waste reclamation site adjacent to the waste reclamation site in succession such that a small bank is formed in the waste reclamation site after the covering of the waste reclamation site with earth; and
an air dome transfer step of transferring the air dome, such that one side of the air dome is supported at the air dome supporting structure and the other side of the air dome is supported at a position located in the advance direction of the new waste reclamation site, to cover the top of the new waste reclamation site with the air dome, wherein
the partial waste stacking step, the air dome supporting structure installation step, the reclamation step, the new waste reclamation site construction step, and the air dome transfer step are repeatedly carried out to continuously fill waste into the waste reclamation sites and to maximize the waste reclamation sites, thereby improving the utilizeability of the waste landfill.

2. The method according to claim 1,
wherein the air dome supporting structure includes a supporting body, made of cement and iron rods, and a rope, and
wherein the supporting body is fixed due to load of the stacked waste, the rope is connected to the supporting body by means of an anchor bolt, and the end of the rope is coupled to one side of the air dome, thereby supporting the air dome.

3. The method according to claim 1, wherein, at the reclamation step, the waste is stacked in the shape of steps in an inclined fashion from the small bank to the air dome supporting structure, whereby the waste is prevented from falling.
